(19) United States
(12) Patent Application Publication
(10) Pub. No.: US 2016/0191394 A1
(43) Pub. Date: Jun. 30, 2016

(54) SATELLITE MODEM TCP ACCELERATION

(71) Applicant: Hughes Network Systems, LLC, Germantown, MD (US)

(72) Inventors: Frank Li, Herndon, VA (US); John Schmid, Darnestown, MD (US)

(73) Assignee: HUGHES NETWORK SYSTEMS, LLC, Germantown, MD (US)

(21) Appl. No.: 14/587,197

(22) Filed: Dec. 31, 2014

(51) Int. Cl. H04L 12/801; H04L 12/855; H04L 29/06

(52) U.S. Cl. CPC H04L 47/193; H04L 69/16; H04L 47/2466

(57) ABSTRACT

A telecommunications system includes a network device that receives a data signal over a first communication network and in accordance with a first communication protocol. The network device generates an acknowledgement command for a remote device to transmit an acknowledgement signal over a second communication network and in accordance with a second communication protocol. The acknowledgement signal acknowledges receipt of the data signal at the network device.

### BACKGROUND

Communication standards provide guidelines for facilitating communication over a particular network. For example, some digital television broadcasts over a satellite network are guided by the Digital Video Broadcasting—Satellite-Second Generation (DVB-S2) standard. Protocols define the rules for communicating data over a communication network. Thus, a protocol can be used to carry out the standard. An example of a communication protocol is the Internet Protocol, which includes the Transmission Control Protocol (TCP) and the Hypertext Transfer Protocol (HTTP).

### BRIEF DESCRIPTION OF THE DRAWINGS

FIG. 1 illustrates an example telecommunications system for receiving a data signal in accordance with one communication protocol and acknowledging receipt of the data signal in accordance with another communication protocol.

FIG. 2 is a block diagram showing example components of the network device of FIG. 1.

FIG. 3 is a flowchart of an example process that may be executed by the network device to acknowledge receipt of the data signal in accordance with a different communication protocol than that in which the data signal was received.

### DETAILED DESCRIPTION

Complying with certain protocols can be computationally demanding on various network devices. For example, the Transmission Control Protocol requires that transmitted packets be acknowledged at the destination. Otherwise, the packets are assumed to have been lost and are resent. Thus, the network device must process and acknowledge each packet since failure to do so will result in additional network traffic in the form of resent packets. If network communication is unusually slow, the acknowledgement may not be received before the packet is resent, causing increased network traffic for a communication network that is already operating at or near its capacity.

One way to avoid such an issue is for the network device to comply with one communication protocol by sending messages over a different network with different protocols. The example telecommunications system described below, therefore, includes a network device that receives a data signal over a first communication network and in accordance with a first communication protocol. The network device generates an acknowledgement command for a remote device to transmit an acknowledgement signal over a second communication network and in accordance with a second communication protocol. The acknowledgement signal acknowledges receipt of the data signal at the network device. In other words, the network device is able to use the second communication network and its associated protocols to comply with the requirements of the protocols associated with the first communication network. Moreover, by using the second communication network, the network device can comply with the first communication protocols without increasing network traffic on the first communication network.

The elements shown may take many different forms and include multiple and/or alternate components and facilities. The example components illustrated are not intended to be limiting. Indeed, additional or alternative components and/or implementations may be used.

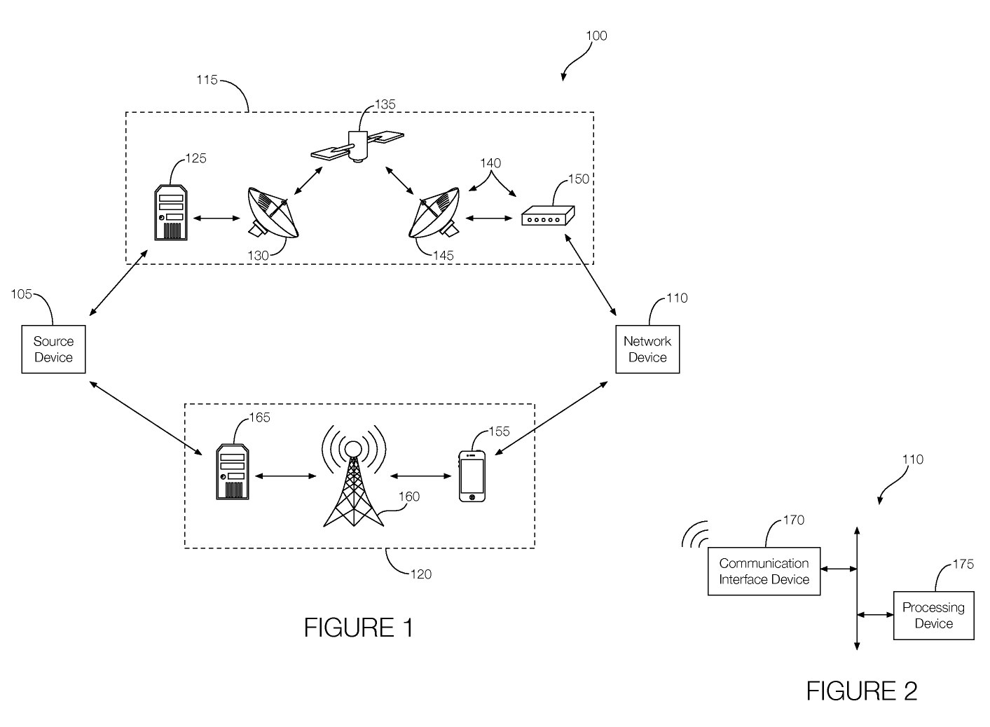

As illustrated in FIG. 1, a telecommunications system 100 includes a source device 105 and a network device 110. The source device 105 and network device 110 are configured to communicate via two network paths—a first communication network 115 and a second communication network 120.

The source device 105 may include any electronic device configured or programmed to transmit and receive messages over the first communication network 115. In some instances, the source device 105 may be configured or programmed to transmit and receive messages according to a first communication protocol. An example of the first communication protocol may include the transmission control protocol (TCP), which is part of the Internet protocol suite.

The network device 110 may include any electronic device configured or programmed to transmit and receive messages according the first communication protocol. In some possible approaches, the network device 110 may include a modem or router. Moreover, the network device 110 may be further configured or programmed to communicate with the remote device. As discussed in greater detail below, the network device 110 may be configured or programmed to transmit commands to the remote device.

The first communication network 115 may include a satellite communication network. Therefore, the first communication network 115 may include a satellite gateway 125, a network management system 130, a satellite 135, and a satellite receiver 140.

The satellite gateway 125 may include any electronic device configured or programmed to facilitate communication between the source device 105 and the first communication network 115. For example, the satellite gateway 125 may convert messages transmitted from the source device 105 into a format that complies with the first communication protocol. The satellite gateway 125 may transmit signals to, e.g., the network management system 130.

The network management system 130 may include any electronic device configured or programmed to control and monitor communications over the first communication network 115 for, e.g., performance. That is, the network management system 130 may facilitate the transmission of signals to certain satellites 135 as well as determine whether the communications over the first communication network 115 meet certain performance criteria for, e.g., satellite network communications. The network management system 130 may receive signals from, e.g., the satellite gateway 125 and transmit signals to, e.g., one or more satellites 135 in orbit around the Earth.

The satellite 135 may include any device in orbit relative to the Earth and configured to receive and transmit signals. The signals may be received from, e.g., the network management system 130. The satellite 135 may broadcast signals back to Earth to be received by a satellite receiver 140, and in particular, an outdoor unit 145.

The satellite receiver 140 may include an outdoor unit 145 and an indoor unit 150. An example outdoor unit 145 may include a satellite dish configured to receive signals transmitted from the satellite 135 in orbit around the Earth. An example indoor unit 150 may include an electronic device, such as a set-top box or modem. The indoor unit 150 may be configured to receive and process signals from the outdoor unit 145. The processed signals may be transmitted to, e.g., the network device 110.

The second communication network 120 may include a cellular communication network. The second communication network 120, therefore, may include a remote device 155, a cellular network interface 160, and a cellular gateway 165.

The remote device 155 may include any electronic device configured or programmed to receive signals from the network device 110 and transmit signals to the cellular network interface 160 in accordance with a second communication protocol, such as a communication protocol associated with cellular communication. Accordingly, the remote device 155 may include, e.g., a mobile phone or tablet computer. Moreover, the remote device 155 may be programmed to wirelessly pair with the network device 110. While paired, the remote device 155 may receive commands and other signals transmitted from the network device 110. In some possible approaches, the remote device 155 may include an application that, when executed, causes the remote device 155 to pair with and receive instructions from the network device 110. Such instructions may include, e.g., transmitting the acknowledgement signal over the second communication network 120 and in accordance with the second communication protocol.

The cellular network interface 160 may include any device configured or programmed to receive signals from the remote device 155 and transmit signals to the cellular gateway 165 according to the second communication protocol. In one possible implementation, the cellular network interface 160 may include a cell tower.

The cellular gateway 165 may include any electronic device configured or programmed to receive communications from the cellular network interface 160 and convert the communications to messages that comply with a different communication protocol. For example, messages from the cellular network interface 160 may be received at the cellular gateway 165 according to the first communication protocol. The cellular gateway 165 may convert the message to a format that complies with the first communication protocol before transmitting the message to the source device 105.

In one possible implementation, the network device 110 may receive a data signal over the first communication network 115 and in accordance with the first communication protocol. The first communication protocol may require that the network device 110 acknowledge receipt of the data signal. Instead of transmitting the acknowledgement over the first communication network 115, the network device 110 may generate an acknowledgement command and transmit the acknowledgement command to the remote device 155. In response, the remote device 155 may generate and transmit an acknowledgement signal over the second communication network 120 and in accordance with the second communication protocol. The cellular gateway 165 may convert the acknowledgment signal into a format that may be received and processed by the source device 105. For instance, the cellular gateway 165 may convert the acknowledgement signal into a format that complies with the first communication protocol. Thus, the acknowledgement signal may acknowledge receipt of the data signal at the network device 110.

The network device 110 may not need to acknowledge all data signals. Therefore, the network device 110 may be programmed to parse the data signal to determine whether an acknowledgement signal must be sent. For instance, the network device 110 may parse the data signal to determine whether the data signal was transmitted in accordance with the first communication protocol. If so, the network device 110 may generate the acknowledgement command and transmit the acknowledgement command to the remote device 155.

When the remote device 155 is within wireless range of the network device 110, the network device 110 and the remote device 155 may engage in a handshaking process resulting in the remote device 155 pairing with the network device 110. The first time a remote device 155 pairs with the network device 110, the remote device 155, the network device 110, or both, may need to authorize the pairing. One way to authorize the pairing is for a code to be entered into the network device 110, the remote device 155, or both.

If multiple remote devices 155 are paired with the network device 110, the network device 110 may select which remote device 155 is to transmit the acknowledgement signal. The network device 110 may include a priority list of each previously paired remote device 155, and the remote device 155 with the highest priority may be used to transmit the acknowledgement signal. Alternatively, one remote device 155 may be selected as the default device for transmitting acknowledgement signals. Thus, the network device 110 may only use the default device to transmit acknowledgement signals when the default device is paired. The network device 110 and the remote device 155 may pair according to any number of wireless communication protocols such as WiFi or Bluetooth®.

FIG. 2 is a block diagram showing example components of the network device 110 of FIG. 1. As shown, the network device 110 includes a communication interface device 170 and a processing device 175.

The communication interface device 170 may include any electronic device configured to facilitate communication over the first communication network 115, the second communication network 120, or both. For example, the communication interface may be configured to receive signals, such as the data signal, transmitted over the first communication network 115 in accordance with the first communication protocol. The communication interface device 170 may be further configured to receive signals transmitted over the second communication network 120 in accordance with the second communication protocol. Moreover, the communication interface device 170 may be configured to transmit messages over the first communication network 115 and the second communication network 120, in accordance with the first and second communication protocols, respectively. For example, the communication interface device 170 may be configured to transmit the acknowledgement command to, e.g., the remote device 155 over the second communication network 120 and in accordance with the second communication protocol. In some implementations, the communication interface device 170 may initiate a handshake or other pairing technique to pair with the remote device 155 or other wireless communication devices. The communication interface device 170 may be configured to communicate, therefore, in accordance with any number of communication protocols, including wireless communication protocols. Examples of such protocols may include, e.g., Bluetooth® or WiFi. The communication interface device 170 may be further configured to transmit messages internally relative to the network interface device. For instance, the communication interface device 170 may transmit signals to, and receive signals from, the processing device 175 over, e.g., a communication bus or other communication link.

The processing device 175 may include any electronic device programmed to process signals received from the communication interface device 170. For instance, the processing device 175 may be programmed to receive the data signal from the communication interface device 170 and process the data signal. Processing the data signal may include parsing the data signal to determine whether it was sent in accordance with the first communication protocol. If so, the processing device 175 may be programmed to generate the acknowledgement command, with an acknowledgement signal acknowledging receipt of the data signal, with instructions for the communication interface device 170 to transmit the acknowledgement command to the remote device 155 over the second communication network 120 and in accordance with the second communication protocol. If multiple devices are paired with the network device 110, the processing device 175 may be further programmed to select which of the paired remote devices 155 is to transmit the acknowledgement signal. The processing device 175 may command the communication interface device 170 to transmit the acknowledgement command to only the selected remote device 155.

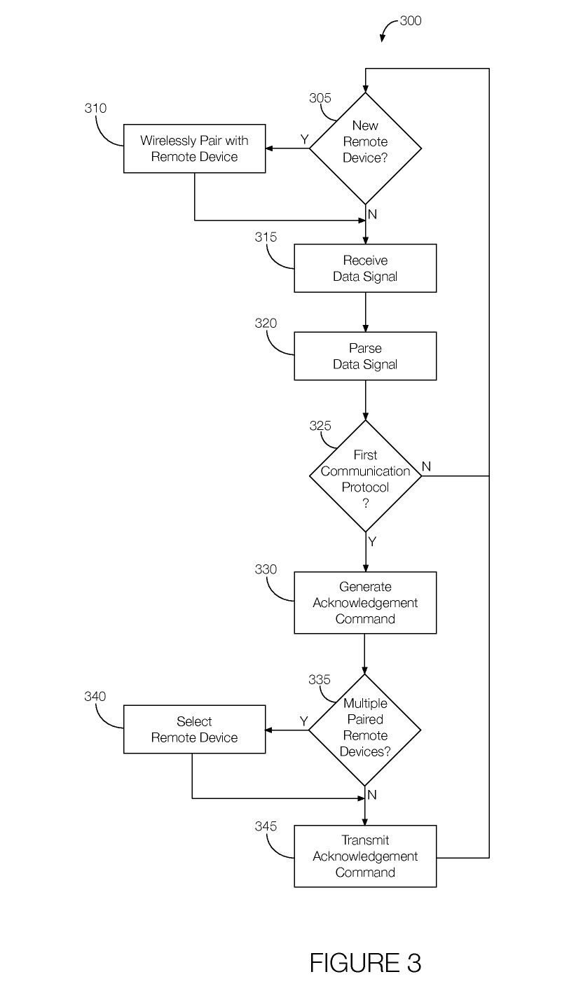

FIG. 3 is a flowchart of an example process 300 that may be executed by the network device 110 to acknowledge receipt of the data signal in accordance with a different communication protocol than that in which the data signal was received. The process 300 may begin when the network device 110 is turned on and certain portions of the process 300 may continue to execute until the network device 110 is turned off.

At block 305, the network device 110 may determine whether a new remote device 155 has been detected. The new remote device 155 may include a remote device 155 within range of the network device 110. The network device 110 may further determine whether the new remote device 155 has previously been paired with the network device 110. When a new remote device 155 is detected, the process 300 may continue to block 310. Otherwise, the process 300 may proceed to block 315. The processing device 175 may detect whether a new remote device 155 has been detected based on, e.g., signals received from the communication interface device 170.

At block 310, the network device 110 may wirelessly pair with at least one remote device 155. When the remote device 155 is within wireless range of the network device 110, the network device 110 and the remote device 155 may engage in a handshaking process resulting in the remote device 155 pairing with the network device 110. The first time a remote device 155 pairs with the network device 110, the remote device 155, the network device 110, or both, may need to authorize the pairing. One way to authorize the pairing is for a code to be entered into the network device 110, the remote device 155, or both. The communication interface device 170 may facilitate the pairing with the remote device 155.

At block 315, the network device 110 may receive a data signal over the first communication network 115 and in accordance with a first communication protocol. As discussed above, the first communication network 115 may include a satellite communication network. The data signal may have been sent from, e.g., the source device 105 to the network device 110 over the first communication network 115. The data signal may be received by the network device 110 via the communication interface device 170, and the communication interface device 170 may transmit the data signal to the processing device 175 for processing.

At block 320, the network device 110 may parse the data signal. Parsing the data signal may include extracting information about the data signal including, e.g., whether the data signal was transmitted over the first communication network 115 and in accordance with the first communication protocol. The data signal may be parsed by, e.g., the processing device 175.

At decision block 325, the network device 110 may determine whether the data signal was transmitted over the first communication network 115 and in accordance with the first communication protocol. If so, the process 300 may proceed to block 330. Otherwise, the process 300 may proceed to block 305. The processing device 175, as discussed above, may be programmed to make such a determination.

At block 330, the network device 110 may generate an acknowledgement command. The acknowledgement command may command one of the paired remote devices 155 to transmit an acknowledgement signal over the second communication network 120 in accordance with the second communication protocol. As discussed above, the acknowledgement signal may acknowledge the network device 110 receiving the data signal transmitted by the source device 105. Moreover, in one possible implementation, the second communication network 120 may include a cellular communication network.

At decision block 335, the network device 110 may determine if multiple remote devices 155 are paired. If so, the process 300 may continue to block 340. Otherwise, the process 300 may continue to block 345. The processing device 175 or the communication interface device 170 may determine whether multiple remote devices 155 are paired.

At block 340, the network device 110 may select one of the paired remote devices 155. The network device 110 may include a priority list of each previously paired remote device 155, and the remote device 155 with the highest priority may be used to transmit the acknowledgement signal. Alternatively, one remote device 155 may be selected as the default device for transmitting acknowledgement signals. Thus, the network device 110 may only use the default device to transmit acknowledgement signals when the default device is paired. The network device 110 and the remote device 155 may pair according to any number of wireless communication protocols such as WiFi or Bluetooth®. The selection of the remote devices 155 may be made by, e.g., the processing device 175 or the communication interface device 170.

At block 345, the network device 110 may transmit the acknowledgement command to the selected remote device 155. The acknowledgement command may be transmitted to the remote device 155 via, e.g., the communication interface device 170 over the second communication network 120. As discussed above, the acknowledgement command may be transmitted in accordance with the second communication protocol.

The process 300 may end after block 345. Alternatively, the process 300 may continue to block 305 so that the process 300 may run continuously until the network device 110 is turned off.

In general, the computing systems and/or devices described may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, New York, the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, a router, a modem, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A telecommunications system comprising:
a network device programmed to receive a data signal over a first communication network and in accordance with a first communication protocol,
wherein the network device is programmed to generate an acknowledgement command for a remote device to transmit an acknowledgement signal over a second communication network and in accordance with a second communication protocol,
wherein the acknowledgement signal acknowledges receipt of the data signal at the network device.

2. The telecommunications system of claim 1, wherein the first communication network includes a satellite communication network and wherein the second communication network includes a cellular communication network.

3. The telecommunications system of claim 1, wherein the network device is programmed to parse the data signal and determine whether the data signal was transmitted in accordance with the first communication protocol.

4. The telecommunications system of claim 3, wherein the network device is programmed to generate the acknowledgement command if the data signal was transmitted in accordance with the first communication protocol.

5. The telecommunications system of claim 1, wherein network device is programmed to pair with the remote device.

6. The telecommunications system of claim 5, wherein the network device is programmed to wirelessly pair with the remote device.

7. The telecommunications system of claim 1, wherein the network device is programmed to pair with a plurality of remote devices and select at least one of the plurality of remote devices to transmit the acknowledgement signal.

8. The telecommunications system of claim 1, wherein the first communication protocol includes the transmission control protocol.

9. A telecommunications system comprising:
a network device programmed to receive a data signal over a first communication network and in accordance with a first communication protocol,
a remote device programmed to transmit an acknowledgement signal over a second communication network and in accordance with a second communication protocol different from the first communication protocol,
wherein the network device is programmed to transmit an acknowledgement command to the remote device, and wherein the remote device is programmed to transmit the acknowledgement signal in response to receiving the acknowledgement command,
wherein the acknowledgement signal acknowledges receipt of the data signal at the network device.

10. The telecommunications system of claim 9, wherein the first communication network includes a satellite communication network and wherein the second communication network includes a cellular communication network.

11. The telecommunications system of claim 9, wherein the network device is programmed to parse the data signal and determine whether the data signal was transmitted in accordance with the first communication protocol.

12. The telecommunications system of claim 9, wherein the network device is programmed to generate the acknowledgement command if the data signal was transmitted in accordance with the first communication protocol.

13. The telecommunications system of claim 9, wherein network device is programmed to pair with the remote device.

14. The telecommunications system of claim 13, wherein the network device is configured to wirelessly pair with the remote device.

15. The telecommunications system of claim 9, wherein the network device is programmed to select the remote device from among a plurality of remote devices.

16. The telecommunications system of claim 9, wherein the first communication protocol includes the transmission control protocol.

17. A method comprising:
receiving a data signal over a first communication network and in accordance with a first communication protocol;
generating an acknowledgement command for a remote device to transmit an acknowledgement signal over a second communication network and in accordance with a second communication protocol, wherein the acknowledgement signal acknowledges receipt of the data signal at the network device; and
transmitting the acknowledgement command to the remote device.

18. The method of claim 17, wherein the first communication network includes a satellite communication network and wherein the second communication network includes a cellular communication network.

19. The method of claim 17, further comprising:
parsing the data signal; and
determining whether the data signal was transmitted in accordance with the first communication protocol.

20. The method of claim 17, further comprising:
wirelessly pairing with a plurality of remote devices; and
selecting at least one of the plurality of remote devices to transmit the acknowledgement signal.
